(19) United States
(12) Patent Application Publication
(10) Pub. No.: US 2009/0082011 A1
(43) Pub. Date: Mar. 26, 2009

(54) Device and Method for Connection Management

(76) Inventors: Chi ZHANG, Fresh Meadows, NY (US); Eyal Peretz, Stony Brook, NY (US)

Correspondence Address: Fay Kaplun & Marcin, LLP/ Motorola, 150 Broadway Suite 702, New York, NY, 10038, US

(21) Appl. No.: 11/860,258

(22) Filed: Sep. 24, 2007

(51) Int. Cl. H04Q 7/20; H04M 1/00

(52) U.S. Cl. 455/426.1; 455/552.1

(57) ABSTRACT

A mobile device comprises a processor and a transceiver. The processor selects from a plurality of connection types for a user plane assisted global position system (AGPS) data transfer. Each connection type includes a priority level where a first selected connection type is based on the priority levels of the connection types. The transceiver establishes a connection to a wireless network using the selection connection type.

### FIELD OF THE INVENTION

The present invention relates generally to a system and method for connection management. Specifically, the connection management pertains to selection of a connection for a data transfer using a user plane of an assisted global positioning system (AGPS).

### BACKGROUND

A mobile unit may be equipped with components that allow a user to utilize the unit in various locations without a need to be permanently connected to an external power supply. The mobile unit may further be equipped to connect to a network. The mobility of the mobile unit and its capability to connect to networks may allow location data to be useful. Thus, the mobile unit may be equipped with a global positioning system (GPS). However, GPS is a satellite based positioning system and is susceptible to several faults such as the urban canyon effect, failure in indoor use or heavy tree cover, etc. The satellites may provide ephemeris data (i.e., orbital information of the particular satellite sending the data) and almanac data (i.e., approximate location of the complete active fleet of satellites).

An assisted global positioning system (AGPS) has been developed to enhance performance of ascertaining the location of a mobile unit. Specifically, an assistance server is utilized in AGPS. The assistance server may have a relatively high computation power and may receive fragmentary signals (as opposed to whole signals) which may be interpreted to determine location data. The assistance server may continuously have a steady satellite signal so the ephemeris and almanac data may be forwarded to the mobile unit as aiding data, thereby time to first fix (TTFF) is shortened, battery life is saved, and/or antenna size is decreased. The aiding data may be transferred via a control plane or a user plane. When transferred over a user plane, the aiding data may appear as user data in a wireless network over a transmission control protocol/internet protocol (TCP/TIP). However, conventional mobile units may only be equipped with a singular mode of transmitting over TCP/IP. Furthermore, the mobile unit may only connect to a certain wireless network where some networks may incur costs.

### SUMMARY OF THE INVENTION

The present invention relates to a device and method for connection management. A mobile device comprises a processor and a transceiver. The processor selects from a plurality of connection types for a user plane assisted global position system (AGPS) data transfer. Each connection type includes a priority level where a first selected connection type is based on the priority levels of the connection types. The transceiver establishes a connection to a wireless network using the selection connection type.

### DESCRIPTION OF THE DRAWINGS

FIG. 1 shows components of a mobile unit according to an exemplary embodiment of the present invention.

FIG. 2 shows a connectivity table according to an exemplary embodiment of the present invention.

FIG. 3 shows a method for connection management according to an exemplary embodiment of the present invention.

### DETAILED DESCRIPTION

The present invention may be further understood with reference to the following description and the appended drawings, wherein like elements are referred to with the same reference numerals. The exemplary embodiments of the present invention describe a system and method for connection management. Specifically, the exemplary embodiments of the present invention may pertain to when a mobile unit (MU) connects to an assisted global positioning system (AGPS) to transfer location data. To connect to the AGPS, the MU may incorporate a user specified prioritization of various connectivity options available to a mobile unit (MU). The MU, the prioritization, and the connectivity options will be discussed in more detail below.

Aiding data of the AGPS may be transferred using a control plane or a user plane. The control plane utilizes control channels of, for example, a cellular network. For example, in a code division multiple access (CDMA) system, a control channel may differentiate itself from a data channel by channel coding. In the user plane, the traffic of aiding information is carried over internet protocol (IP) bearers. In particular with AGPS, signaling and position data may be transferred over transmission control protocol/internet protocol (TCP/IP) and may appear as user data to a wireless network. In either plane, the data may be sent in the form of, for example, radio frequency (RF) signals.

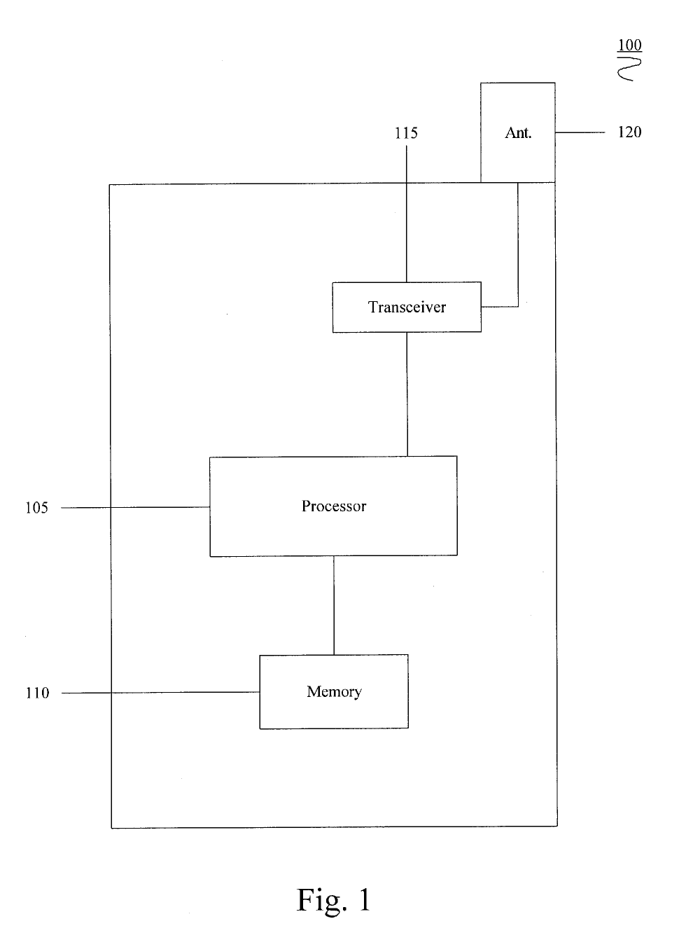

FIG. 1 shows an inner view of an MU 100 according to an exemplary embodiment of the present invention. The MU 100 may be any device that utilizes a portable power supply (e.g., a battery, a capacitor, a supercapacitor, etc.). For example, the MU 100 may be a mobile computer, a personal digital assistant (PDA), a laptop, a pager, a cell phone, a radio frequency identification device, a scanner, etc. It should be noted that the use of the MU 100 is only exemplary. That is, the exemplary embodiments of the present invention may apply to any electronic device that may connect to a network and be equipped with a positioning system. The MU 100 may include a processor 105, a memory 110, a transceiver 115, and an antenna 120. It should be noted that the MU 100 may include further components such as a display and a data input arrangement.

The processor 105 may be responsible for executing various functionalities of the MU 100. Specifically, according to the exemplary embodiments of the present invention, the processor 105 may perform the connection management. The memory 110 may be a storage unit for the MU 100. As will be explained in detail below, the memory 110 may store the user specified prioritization of various connectivity options. The memory 110 may also store an operating system installed on the MU 100. The operating system may include the positioning program. It should be noted that the positioning program may be separate from the operating system and also installed and stored on the memory 100 to be executed by the processor 105.

The transceiver 115 and the antenna 120 may be components of the MU 100 that allow the MU 100 to connect to a wireless network. The transceiver 115 may be equipped so that the MU 100 may connect to more than one wireless network. For example, the transceiver 115 may connect to a wireless network when the MU 100 is located within an operating area of the wireless network. When the MU 100 is located within an operating area of multiple wireless networks, the transceiver 115 may connect to any of the wireless networks. The transceiver 115 may connect to a wireless network utilizing conventional connection methods. According to the exemplary embodiments of the present invention, when pertaining to the positioning system, a data transfer may be performed using the user plane of the AGPS (hereinafter “user plane AGPS data transfer”).

It should be noted that the antenna 120 may send data packets to a switch of the wireless network in a conventional manner. Furthermore, it should be noted that the antenna 120 being external is only exemplary. For example, the antenna 120 may also be internal. Those skilled in the art will understand that the MU 100 connecting to a particular wireless network may require authentication and authorization to connect thereto. For example, a user of the MU 100 may be required to subscribe to a provider of a wireless network, to input a user name and/or password, etc.

As discussed above, the transceiver 115 may allow the MU 100 to connect to different types of wireless networks. For example, the transceiver 115 may allow the MU 100 to establish a TCP/IP connection for the user plane AGPS data transfer using a wireless wide area network (WWAN), a wireless local area network (WLAN), a Bluetooth connection, an ActiveSync connection, a wireless private area network (WPAN), etc. As will be explained in detail below, a user may determine which type of connectivity is to be made and may also determine a priority list of the types of connectivity. It should be noted that the use of a singular transceiver 115 is only exemplary. That is, the MU 100 may include a different transceiver to establish a connection with the various types of connectivity. For example, a transceiver may be disposed to connect to the WWAN, a transceiver may be disposed to connect to the WLAN, etc. Furthermore, it should be noted that a common transceiver may be used to connect to more than one type of connectivity. For example, a single transceiver may connect to the WWAN and the WLAN.

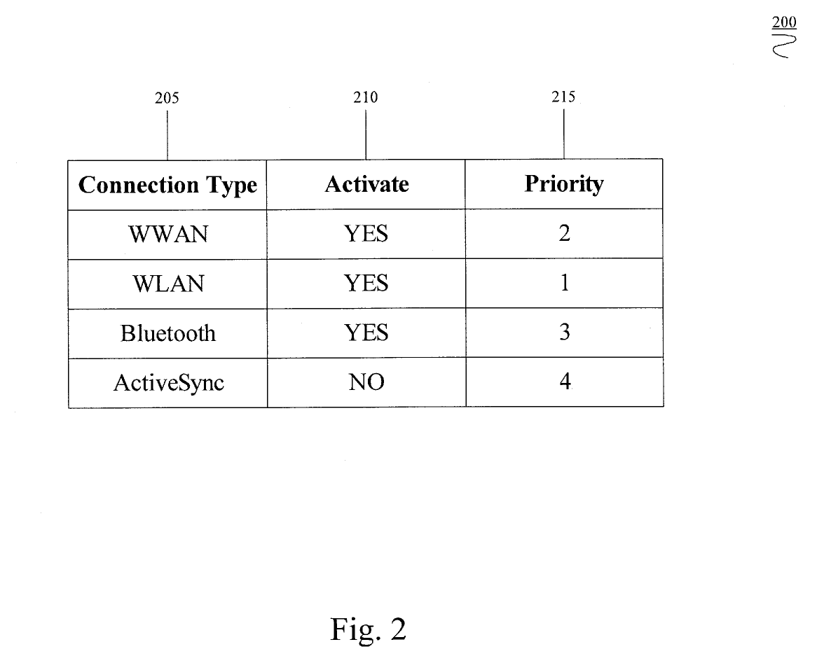

FIG. 2 shows a connectivity table 200 according to an exemplary embodiment of the present invention. The connectivity table 200 will be discussed with reference to the MU 100 of FIG. 1. As discussed above, the MU 100 may be equipped with the transceiver 115 that enables the MU 100 to establish a TCP/IP connection for the user plane AGPS data transfer via different types of connectivity (e.g., WWAN, WLAN, Bluetooth, ActiveSync, etc.). The connectivity table 200 may be a result of a user prioritizing the different types of connectivity. The user may be presented with an applet/dialog box, registry settings, and/or an XML file on the display of the MU 100 instructing the user to enter the prioritization. The user may enter the prioritization via the data input arrangement of the MU 100. It should be noted that the user may manually enter the different types of connectivity, be presented with a list of the available types of connectivity, etc.

The connectivity table 200 may include three columns. The first column 205 may include the different types of connectivity. The second column 210 may include an activation determination. The third column 215 may include a priority. As shown, the first column 205 may include four different types of connections. That is, the MU 100 may establish a TCP/IP connection for the user plane AGPS data transfer using the four different types of connections: WWAN, WLAN, Bluetooth, and ActiveSync. The second column 210 may indicate that the WWAN, the WLAN, and the Bluetooth connections are activated while the ActiveSync connection is deactivated. The third column 215 may indicate that the WWAN has a priority of “2,” the WLAN has a priority of “1,” the Bluetooth has a priority of “3,” and the ActiveSync has a priority of “4.” Thus, when the MU 100 attempts to establish a TCP/IP connection for the user plane AGPS data transfer, an operating system of the MU 100 may first attempt a connection to the WLAN, then the WWAN, then the Bluetooth, and finally the ActiveSync. However, because the ActiveSync has been deactivated, the operating system may not attempt the connection to the ActiveSync.

It should be noted that the connectivity table 200 including four different types of connections is only exemplary. As discussed above, other types of connections exist and the connectivity table 200 may incorporate these other types. Furthermore, it should be noted that the activation determination is only exemplary and other combinations of activation for the types of connections may exist. In addition, it should be noted that the priority list shown in column 215 is only exemplary and the user may enter a different priority list.

It should also be noted that the connectivity table 200 may be alterable. That is, the user may change the values of the connectivity table 200 depending on, for example, an area in which the MU 100 is located. Thus, additional connection types may be entered into column 205; activation/deactivation of the connection types may be different since any connection type may be available in one location but unavailable in another; and the priority may be different since one connection may be poor in one location but may be optimal in another location. It should also be noted that the storage of the connectivity settings in a table is only exemplary. Other manners of storing the connectivity settings may be used such as a database, a list, an array, an XML file, a text file, etc.

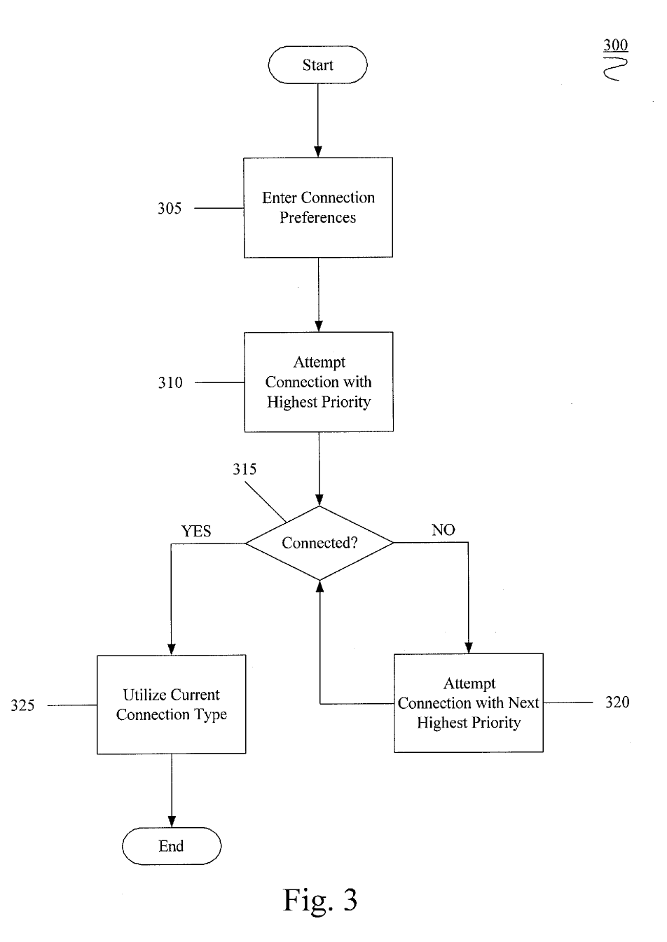

FIG. 3 shows a method 300 for connection management according to an exemplary embodiment of the present invention. The method 300 will be discussed with reference to the MU 100 of FIG. 1 and the connectivity table 200 of FIG. 2. The method 300 may be a series of steps executed on the operating system when attempting to establish a connection for the user plane AGPS data transfer. It should again be noted that the connection may be embodied in a separate program executed by the processor 105 and stored on the memory 110.

In step 305, connection preferences may be entered. As discussed above, the connectivity table 200 may represent the preferences inputted by a user. The preferences may include the various types of connections represented in column 205, the activation/deactivation of the various types represented in column 210, and the priority of the various types represented in column 215. Thus, once the connectivity table 200 has been created, a prioritization list may be established.

In step 310, a connection with the highest priority may be attempted. As shown in the connectivity table 200, the WLAN has the highest priority among the different types of connections entered in column 205. Thus, the operating system or connectivity program may initially attempt to establish a TCP/IP connection for the user plane AGPS data transfer. It should again be noted that the WLAN having the highest priority is only exemplary and the user may have entered that the WWAN, the Bluetooth, or the ActiveSync has the highest priority.

In step 315, a determination is made whether a connection has been established using the highest priority connection. This determination may be made when a priority list has been created into the connectivity table 200. However, as will be discussed in another embodiment below, the determination of step 315 may result in a different set of subsequent steps.

If step 315 determines that the MU 100 has not established a connection for the user plane AGPS data transfer using the highest priority connection type, the method 300 continues to step 320. In step 320, a connection with the next highest priority may be attempted. As shown in the connectivity table 200, the WWAN has the next highest priority among the different types of connections entered in column 205. Thus, the operating system or connectivity program may then attempt to establish a TCP/IP connection for the user plane AGPS data transfer with the WWAN. It should again be noted that the WWAN having the next highest priority is only exemplary and the user may have entered that the WLAN, the Bluetooth, or the ActiveSync has the next highest priority.

The method 300 returns to step 315 and another determination is made whether the MU 100 established a connection for the user plane AGPS data transfer using the next highest priority connection. Steps 315 and 320 may be iterated until a connection has been established. The steps 315 and 320 may be iterated only for the types of connections of column 205 that have been indicated as activated in column 210. An additional step may be present that determines if no other types of connections are possible. If no other types of connections are possible, a display may indicate to the user that the connection attempts have failed. In another embodiment, a display may indicate that another attempt may be made in a given time period, until a predetermined signal strength has been established, etc.

If step 315 determines that a connection has been established from the attempt in step 310 (e.g., highest priority) or the attempt in step 320 (e.g., a lower priority), the method 300 continues to step 325. In step 325, the connection type that was successful may be utilized for the user plane AGPS data transfer. The result of the above steps may allow the highest available priority connection type to be used in step 325 at all times. If a lower priority connection type is used in step 325, a continuous attempt at higher priority connections may be attempted. Once a connection is established using a higher priority connection, a subsequent step may exist that may include a display to the user indicating that the higher priority connection is available. The user may decide to disconnect from the current lower priority connection to the higher priority connection or to remain connected to the lower priority connection.

It should be noted that the priority list embodied in the connectivity table 200 is only exemplary. In another embodiment, the user may select a preferred connection. The preferred connection may then be used for the user plane AGPS data transfer. The method 300 may be modified for this embodiment. That is, the user may enter the preferred connection. The MU 100 may attempt to establish the preferred connection. When the attempt fails, further attempts may be made to establish the preferred connection where the further attempts are based on, for example, time, signal strength, battery capacity, etc. If after a certain number of attempts a connection is still not established, a display may indicate the failure.

A conventional MU may only allow a user to establish a connection for the user plane AGPS data transfer with a single option. The single option may force the user to connect to a slower connection speed, to be required to pay for the service, etc. The exemplary embodiments of the present invention may allow a user increased options when attempting to establish a connection for the user plane AGPS data transfer. By allowing a user to select the type of connection to be established, the user may have more control to the connection speed and costs involved with the user plane AGPS data transfer. For example, in a first area, the WLAN connection may be optimal. Thus, the user may place the highest priority on the WLAN. However, in a second area, the Bluetooth connection may be optimal. Thus, the user may place the highest priority on the Bluetooth. In another example, the WWAN connection may be optimal but requires the user to increase costs for the user plane AGPS data transfer. Thus, the user may weigh the options of a higher connection speed and increased costs to a lower connection speed and lower costs.

Throughout this description, it was described that the user of the MU may set the connectivity preferences. However, it may also be possible that connectivity preferences are set by a manufacturer, by a system administrator, etc. In addition, instead of entering the connectivity preferences manually via a data input arrangement of the MU, it may also be possible to receive or download a file that includes the connectivity preferences.

Those skilled in the art will understand that the above described exemplary embodiments may be implemented in any number of manners, including, as a separate software module, as a combination of hardware and software, etc. For example, the method 300 may be a program containing lines of code that, when compiled, may be executed on the processor 105.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile device, comprising:
a processor selecting from a plurality of connection types for a user plane assisted global positioning system (AGPS) data transfer, each connection type including a priority level, a first selected connection type being based on the priority levels of the connection types; and
a transceiver establishing a connection to a wireless network using the selected connection type.

2. The mobile device of claim 1, further comprising:
a display displaying a user interface including the plurality of connection types and the corresponding priority levels.

3. The mobile device of claim 2, wherein the user interface is one of an applet/dialog box, registry settings, and an XML file.

4. The mobile device of claim 2, wherein the priority levels are alterable by a user via the user interface.

5. The mobile device of claim 1, wherein the first selected connection type has a highest priority level.

6. The mobile device of claim 5, wherein the processor selects a second selected connection type that is different from the first selected connection type based on the priority levels when the transceiver fails to establish the connection to the wireless network using the first selected connection type.

7. The mobile device of claim 6, wherein the second selected connection type has a next highest priority level.

8. The mobile device of claim 1, wherein each connection type further includes an activation status and the selection is further based on the activation statuses of the connection types.

9. The mobile device of claim 8, wherein a user may deactivate select ones from the plurality of connection types, thereby preventing the processor from selecting the select ones.

10. The mobile device of claim 1, wherein the plurality of connection types includes at least one of a wireless wide area network, a wireless local area network, a Bluetooth connection, an ActiveSync connection, and a wireless private area network.

11. A method, comprising:
receiving connection preferences relating to a user plane AGPS data transfer;
selecting one of a plurality of connection types based on the connection preferences; and
establishing a connection to a wireless network using the selected connection type.

12. The method of claim 11, wherein the connection preferences include a priority list of the plurality of connection types.

13. The method of claim 12, further comprising:
selecting a different connection type based on the priority list when the connection to the wireless network fails using the one of the selected connection types.

14. The method of claim 12, wherein the priority list is alterable by a user.

15. The method of claim 14, further comprising:
displaying a user interface to the user, the user interface receiving at least one input to alter the priority list.

16. The method of claim 11, wherein the plurality of connection types includes at least one of a wireless wide area network, a wireless local area network, a Bluetooth connection, an ActiveSync connection, and a wireless private area network.

17. The method of claim 11, further comprising:
deactivating, by a user, select ones from the plurality of connection types, thereby preventing the select ones from being selected.

18. The method of claim 11, further comprising:
displaying a user interface indicating a failure to connect to the wireless network.

19. A mobile device, comprising:
a processing means for selecting from a plurality of connection types for a user plane assisted global positioning system (AGPS) data transfer, each connection type including a priority level, a first selected connection type being based on the priority levels of the connection types; and
a transceiver means for establishing a connection to a wireless network using the selected connection type.

20. A computer readable storage medium including a set of instructions executable by a processor, the set of instructions operable to:
receive connection preferences relating to a user plane AGPS data transfer;
select one of a plurality of connection types based on the connection preferences; and
establish a connection to a wireless network using the selected connection type.
